(19) United States
(12) Patent Application Publication
(10) Pub. No.: US 2001/0045920 A1
(43) Pub. Date: Nov. 29, 2001

(54) Projection screen for multiplanar volumetric display

(76) Inventors: Deirdre M. Hall, Beverly, MA (US); Rick K. Dorval, Goffstown, NH (US); Gregg E. Favalora, Cambridge, MA (US)

Correspondence Address: ERIC L. PRAHL, Fish & Richardson P.C., 225 Franklin Street, Boston, MA, 02110-2804, US

(21) Appl. No.: 09/828,501

(22) Filed: Apr. 6, 2001

Related U.S. Application Data
(60) Provisional application No. 60/194,947, filed on Apr. 6, 2000.

(51) Int. Cl. G09G 3/00

(52) U.S. Cl. 345/32

(57) ABSTRACT

The invention features a spinning screen assembly that incorporates a thin projection screen held in place by a hollow transparent mount. The mount may be spherical in overall shape. A projection system projects portions of a 3-D image onto the projection screen. A control electronics subsystem coordinates other subsystems, including the projection system and a source of image data. Persistence of vision causes a viewer to perceive a volumetric image from a series of projections. The thinness of the projection screen reduces visual dead zones. Enclosing the projection screen within the screen assembly reduces the air resistance that the thin screen is exposed to during rotation. In a further embodiment, a stationary hemispherical transparent dome covers the spinning screen assembly.

### RELATED APPLICATION

Under 35 USC §119(e)(1), this application claims the benefit of prior U.S. provisional application 60/194,947, filed Apr. 6, 2000.

### TECHNICAL FIELD

This invention relates to electronic display technology, and more particularly to projection screens for multiplanar volumetric 3-D displays.

### BACKGROUND

Multiplanar three-dimensional (hereinafter “3-D”) displays produce 3-D imagery by illuminating a projection screen undergoing periodic motion. FIG. 1 shows an example of such a projection screen. In operation, projection screen 5 rotates about axis 10 (or “sweeps”) through a 3-D display volume 15. One or more light sources (not shown) are used to project zero-dimensional (hereinafter “0-D”) or one-dimensional (hereinafter “1-D”) or two-dimensional hereinafter “2-D”) images onto surfaces 20 and 25 of projection screen 5 as it rotates. The images, coupled with the persistence of human vision, cause a volume-filling (or “volumetric”) 3-D image 30 to be perceived by a viewer as projection screen 5 rotates.

Existing swept-screen 3-D displays are plagued with dark viewing regions, known as visual dead zones, which occur wherever sections of the projection screen are coplanar with a viewer's line of sight. FIG. 2, which is a top view of projection screen 5, illustrates this phenomenon. As shown, a viewer at location 40 will perceive a dark region in a resulting 3-D image due to insufficient light emanating from the screen in the viewer's line of sight 35.

Another disadvantage of existing moving-screen 3-D display technology is their susceptibility to image jitter caused by the screen's movement through air. A further disadvantage of existing moving-screen 3-D displays is the visibility of the moving projection surface in ambient light.

Therefore, existing spinning-screen volumetric display technologies suffer from the existence of certain darkened viewing zones, exhibit image jitter due to air resistance, and possess the undesirable characteristic of having a perceivable spinning screen.

### SUMMARY

In general, in one aspect, the invention features a spinning screen assembly that incorporates a thin projection screen held in place by a hollow transparent mount. Portions of the overall 3-D image are projected onto the projection screen.

One embodiment of the invention features a spherical screen assembly. The spherical screen assembly includes spherical sections and a rotating planar diffusive projection screen.

In a particular embodiment, the sections are two spherical halves. The projection screen is thin, disk-shaped, and 50% reflective and 50% transmissive. The projection screen is mounted between the spherical sections. The spherical sections are transparent, hollow, and truncated. The spherical screen assembly rotates, causing the membranous projection screen to sweep out a spherical image volume.

A projection system, situated beneath the spherical screen assembly, emits a series of image “slices” which comprise a 3-D image. In one embodiment, the slices are 2-D, but in other embodiments the slices may be 0-D or 1-D. The slices are reflected off two relay mirrors that are attached to the screen assembly in a manner that keeps the optical path length invariant with the screen assembly's rotational angle. Persistence of vision fuses the multiplicity of image slices into a sharp 3-D image. Also, in this embodiment, a stationary hemispherical dome covers the spinning screen assembly.

In one aspect, the invention provides an image with minimized brightness variation by ensuring that optical energy will reach at least one of the eyes of the viewer. In another aspect, the projection screen's mounting system allows the invention to minimize image jitter due to air turbulence interacting with the rotating screen assembly.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a typical screen assembly for a multiplanar 3-D display in the prior art.

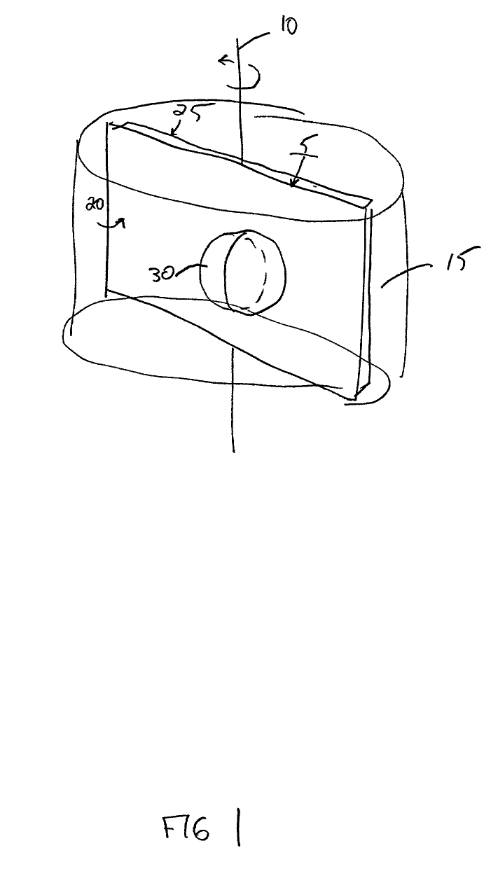

FIG. 2 shows the production of a visual dead zone.

FIG. 3 shows a typical multiplanar 3-D display system.

FIG. 4 shows the construction of a membranous screen assembly mounted within two truncated spherical halves.

FIG. 5 shows the entire 3-D display system.

Like reference symbols in the various drawings indicate like elements.

### DETAILED DESCRIPTION

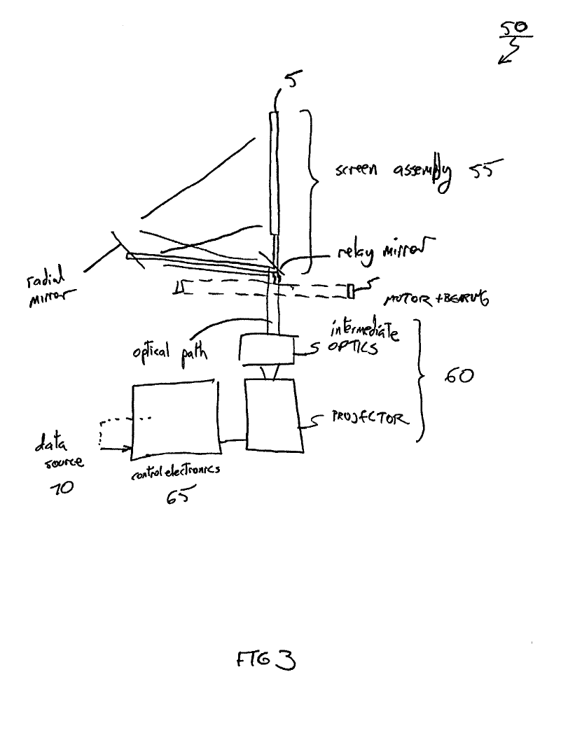

FIG. 3 shows an embodiment of a 3-D display system 50 in which the invention may be implemented. As shown in FIG. 3, display system 50 is comprised of four basic components: screen assembly 55, projection optics 60, control electronics 65, and data source 70. Data source 70 may be external (such as a computer or a data stream) or internal (such as imagery created by data already in the 3-D display system). Data source 70 is operated on by control electronics 65, which includes memory, processor, and timing signal reception and generation. Control electronics 65 performs operations on data and creates drive signals for projection optics 60. Data operations may include rotating projected images in coordination with the rotation of screen assembly 55 to compensate for rotation differences between screen assembly 55 and projection optics 60.

Projection optics 60 includes means for high-speed generation of image slices, illumination, and focusing. Projection optics 60 sends image signals along an optical path to screen assembly 55. A viewer can perceive a 3-D image when a sequence of screen illumination patterns is projected onto the rotating projection screen 5.

The screen assembly 55 rotates with a coaxially-mounted relay mirror and a radial mirror mounted on an extended arm. In one embodiment, the screen assembly 55, relay mirror, and radial mirror are configured such that the length of the optical path is constant.

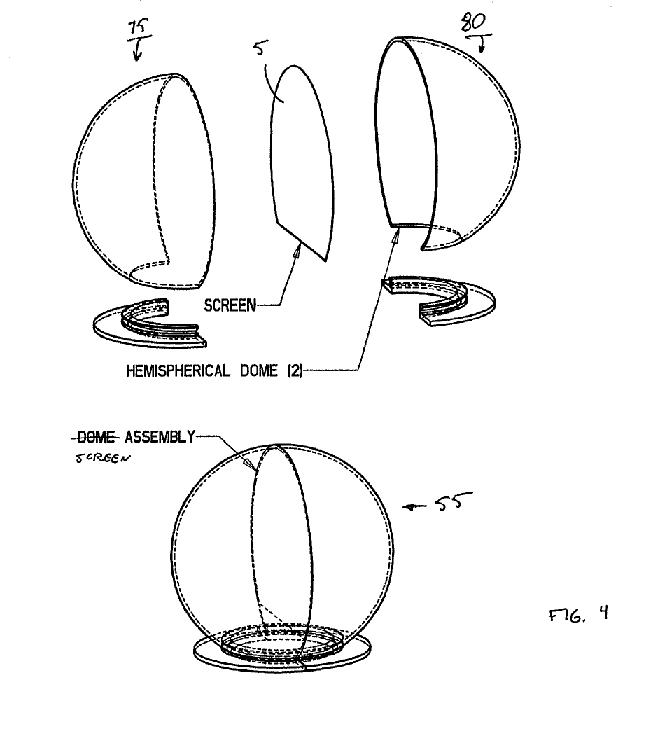

FIG. 4 illustrates components of screen assembly 55. The projection screen 15 is mounted between spherical sections 75 and 80. The spherical sections are transparent, hollow, rigid, and truncated. The spherical sections may be coated with antireflective means. The screen assembly 55 includes projection screen 5 and is partially or completely encapsulated in a transparent dome assembly comprised of left hemispherical dome 75 and right hemispherical dome 80. When assembled, the screen assembly is similar to a transparent hollow truncated sphere with a projection screen insert. The projection screen 5 is held rigid with the screen assembly 55. A motor (not shown) rotates the screen assembly 55 responsive to control signals from control electronics 65. Rotation is at rates greater than or equal to 600 rpm. An advantage of enclosing the projection screen 15 within the screen assembly 55 is that the enclosure reduces the air resistance that the projection screen 15 is exposed to during rotation.

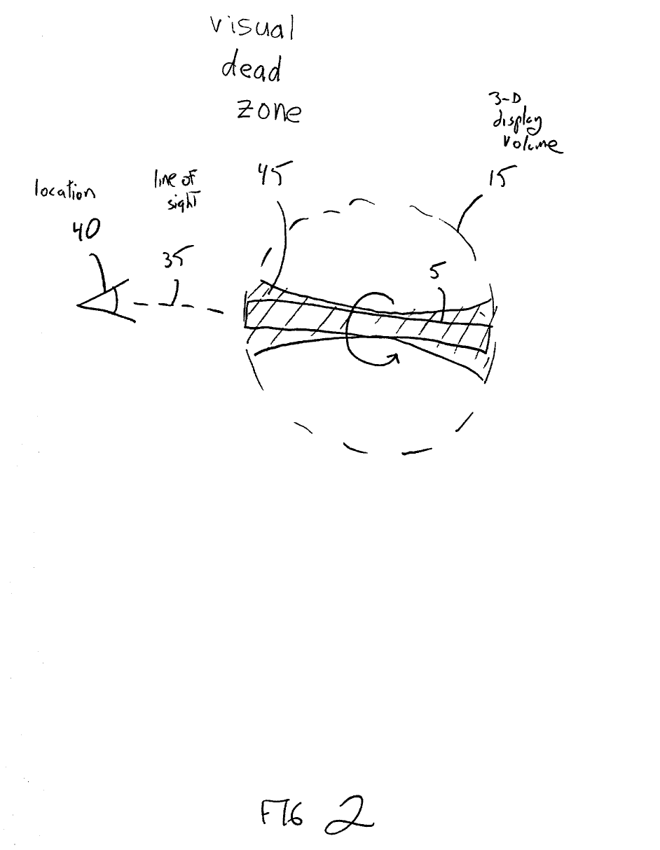

The projection screen 5 may be thin (less than 1 mm), which reduces the dark-region behavior of the prior art (see FIG. 2). The projection screen 5 may be disk-shaped or disk-shaped with a truncation corresponding to the truncation of the spherical sections. Perceived imaging is improved when the projection screen 5 includes material that is optically 50% reflective and 50% transmissive of the projected images and is furthermore Lambertian, i.e., radiates its diffused optical power equally in all directions. In particular, in one aspect, the perceived brightness of the projected images will be more uniform throughout the range of rotation of the projection screen 5 if the projection screen 5 has optical reflectivity equal to its optical transmissiveness: projected images will, in general, have a brightness viewed from the front of the projection screen 5 that is equal to the brightness as viewed from the back, while Lambertian diffusion gives similar brightness across all angles from which the projection screen 5 is viewed. The projection screen 5 may include vellum; however, other materials may be used, such as a layer of paint on a thin substrate, or a material composed of microelements with optical properties (such as a sheet of microspheres).

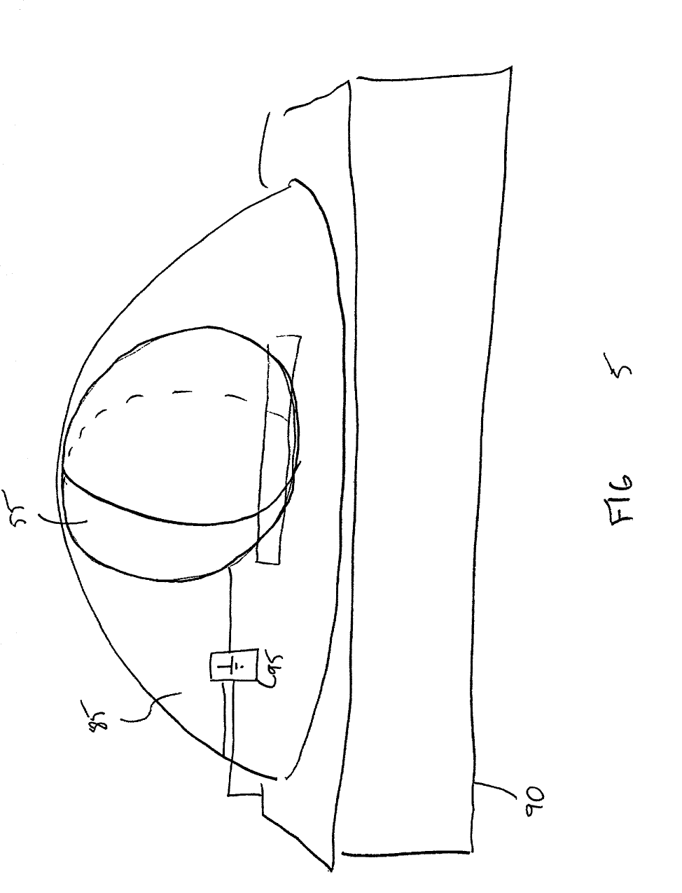

FIG. 5 illustrates a placement of the screen assembly in the 3-D display system. A package 90 contains the electro-optical system described above, including the screen assembly 55. In one embodiment, a viewing dome 85 is positioned outside the rotating screen assembly and is also coated with antireflective means. Furthermore, to prevent the buildup of a significant electric potential (voltage) between any component of the viewing system and electric ground, an electrostatic discharge protection system 95 may be included.

A number of embodiments of the invention have been described. Nevertheless, it will be understood that various modifications may be made without departing from the spirit and scope of the invention. For example, the screen assembly 55 may be of other shapes, such as a cylinder, a complete (non-truncated) sphere, or any solid, although there are advantages to the solid's having symmetry about the rotational axis (for balance and for minimized air resistance) and being as optically neutral as possible (facets may cause unwanted reflections, diffraction, and so forth). The projection screen 5 may be of a shape other than a disk, such as a rectangular plane or helix. Optical elements may perform image enhancement (of brightness, viewing angle sensitivity, etc.) or may vary the color or brightness of the image or sections of the image; for instance, to equalize the apparent 3-D image brightness regardless of position from the axis of rotation.

Accordingly, other embodiments are within the scope of the following claims.

What is claimed is:

1. A display system, the display system comprising:
a screen assembly comprising:
a thin projection screen; and
a plurality of spherical sections, such that the sections form substantially a sphere with the projection screen held therein, the spherical sections being transparent, rigid, and hollow, and the projection screen being substantially equally reflective and transmissive.

2. The display system of claim 1, wherein the screen assembly rotates symmetrically about an axis.

3. The display system of claim 2, further comprising:
a data source that provides images for volumetric display;
a projection optics subsystem that projects a series of images from the data source for display on the projection screen, such that the series as perceived by a viewer appears volumetric; and
a control electronics subsystem that perform operations on data including data from the data source and coordinates operations of the screen assembly, the data source, and the projection optics.

4. The display system of claim 3, wherein the plurality of spherical sections includes two truncated spherical halves.

5. The display system of claim 3, wherein the projection screen lies in a plane which includes the axis about which the screen assembly rotates.

6. The display system of claim 3, wherein the projection screen is substantially disk shaped.

7. The display system of claim 6, wherein the projection screen has a truncation corresponding to a truncation of the plurality of spherical sections.

8. The display system of claim 3, wherein the projection screen is helix shaped.

9. The display system of claim 3, wherein the projection screen includes vellum.

10. The display system of claim 3, wherein the projection screen includes a layer of paint disposed on a thin substrate.

11. The display system of claim 3, wherein the projection screen includes a sheet of microspheres having optical properties.

12. The display system of claim 3, wherein the projection optics subsystem projects two-dimensional images.

13. The display system of claim 3, wherein the projection optics subsystem projects one-dimensional images.

14. The display system of claim 3, wherein the projection optics subsystem projects zero-dimensional images.

15. The display system of claim 3, wherein the control electronics subsystem performs operations on data from the data source to compensate for positional differences between the screen assembly and the projection optics subsystem.

16. The display system of claim 4, wherein the rotating screen assembly is included within a transparent viewing dome.

17. A method for volumetric display, the method comprising:
providing a rotating screen assembly, the screen assembly comprising a thin projection screen and a plurality of spherical sections, such that the sections form substantially a sphere with the projection screen held therein, the spherical sections being transparent, rigid, and hollow, and the projection screen being substantially equally reflective and transmissive;
providing a data source that provides images for volumetric display;
projecting a series of images from the data source for display on the projection screen, such that the series as perceived by a viewer appears three-dimensional; and
coordinating the rotating screen assembly, the data source, and the projection via a control electronics subsystem that perform operations on data including data from the data source.

18. The method of claim 17, wherein the plurality of spherical sections includes two truncated spherical halves and the projection screen is substantially disk shaped.

19. A display system, the display system comprising:
a screen assembly comprising:
a thin projection screen; and
a plurality of sections, such that the sections form a surface having substantially uniform symmetry about an axis, the projection screen held within the surface, the sections being transparent, rigid, and hollow, and the projection screen being substantially equally reflective and transmissive.
